(19) United States
(12) Patent Application Publication
(10) Pub. No.: US 2010/0050267 A1
(43) Pub. Date: Feb. 25, 2010

(54) METHOD AND SYSTEM FOR THE AUTOMATED TRANSFORMATION OF ACCESS CONTROL MANAGEMENT INFORMATION IN COMPUTER SYSTEMS

(76) Inventor: ZOLTAN NOCHTA, Karlsruhe (DE)

Correspondence Address: SAP AG, 3410 HILLVIEW AVENUE, PALO ALTO, CA, 94304, US

(21) Appl. No.: 12/194,573

(22) Filed: Aug. 20, 2008

(51) Int. Cl. G06F 21/00

(52) U.S. Cl. 726/27

(57) ABSTRACT

A system for the automatic transformation of access control data between a source and a target is described. The system includes a source module comprising access control data for a first computing system, a target module comprising access control data for a second computing system, a source transformer module to create an access control matrix based on the access control data in the source module, and a target transformer module to convert the data from the access control matrix according to the access of the target module for the second computing system.

### FIELD OF THE INVENTION

The invention relates generally to heterogamous computing environments, and, more specifically, to transforming access control information in computing environments.

### BACKGROUND OF THE INVENTION

The IT industry has an increasing demand for the integration of distributed and heterogeneous software systems that are specialized for certain tasks. The combined usage of such systems allows setting up complex scenarios, such as multi-tier applications, web service mesh-ups, intra- or inter-company business workflows, and so on. Using unified communication methods and protocols, an application that serves specific user needs can contain invocations of multiple remote heterogeneous systems and/or web services.

One important aspect while using multiple systems in the same application context is the seamless and secure enforcement of access control policies at each of the respective target systems. In general, access control has the task to decide whether a given remote or local user has sufficient rights (i.e. permissions) to execute a given function on a target system resource, such as opening, reading, writing, or deleting a file.

There is a high variety of models to administer and manage access control related information as well as to safely use that data in runtime during access control decisions. Examples for widely accepted and highly varying access control models are Role-based Access Controls (used enterprise portal applications), Group-based Access Controls (used in most operating systems, relational databases, and file systems), Security Label based Access Controls (used in military applications), and so on.

If an application involves two or more target systems each providing some required functionality while using different access control enforcement mechanisms, the administrator of this application manually makes sure that application users have sufficient access to each of those target systems and resources. The administrator creates user accounts and assigns the respective user rights to these users, e.g., by creating/editing new roles, user groups, etc. depending on the access control model of the respective target system, which he has to be sufficiently familiar with in order to avoid mistakes. In addition to initial assignment, the administrator also has to continuously update user rights by future changing requirements.

Another complicated and error prone task is access control information migration when migrating data from a legacy system to another system that uses a different access control management model.

### SUMMARY OF THE INVENTION

A system and method for the automated transformation of access control data between source and target systems is described. The source and target systems include specific access control models that are read by transformer modules. Transformer modules convert access control data from the source to an access control matrix and from the access control matrix to the target access control model.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a bock diagram of a system of an embodiment of the invention for transforming access control information from a source system to a target system;

FIG. 2 is a flow diagram of an embodiment of the invention for extracting and converting access control information;

FIG. 3 is a flow diagram of an embodiment of the invention for extracting an access control model from a source system;

FIG. 4 is a flow diagram of an embodiment of the invention for extracting an access control model from a target system;

FIG. 5 is a flow diagram of an embodiment of the invention for building an access control matrix from the access control model of FIG. 3;

FIG. 6 is a flow diagram of an embodiment of the invention for converting the access control matrix of FIG. 5;

FIG. 7 is a block diagram of a system of another embodiment of the invention.

### DETAILED DESCRIPTION

A system and method for transforming access control information between source and target systems are described. Each source and target system has an access control model. The access control model defines a set of system resources, a set of actions, and a set of users, and relationships between the users, resources, and actions. The data included in the access control model is also referred to as “access control data”. Examples of system resources are files, database tables, connections, and so on. Examples of actions are read, write, delete, modify, and so on. Each user of a system is listed in the access control model with a full specification of the actions the user is permitted to execute on each resource. For example, a user may be permitted to read a file, but not to modify the file. In this case, the relationship between the user and the resource is that he is allowed to read but not allowed to modify.

Each source and target system encodes the information in its access control model differently. This is due to a number of factors. First, each system has a specific architecture. Second, systems run a variety of operating systems. Third, many systems are developed and deployed for a specific purpose and use case. Because of these and other factors, systems use a variety of access control models. For example, a system may use a role-based model, in which, the access control information is specified on a role basis. That is, actions and resources are assigned to roles, and roles are assigned to users. In a different type of model, such as a group-based model, the access control information is encoded in the model on a group basis. That is, actions and resources are assigned to groups, and then users assigned to a respective group.

In the system and method described herein, an intermediate model is used to enable the conversion between differently encoded access control models. This intermediate model is referred to as an “access control matrix”. The access control data in it is encoded in a generic format.

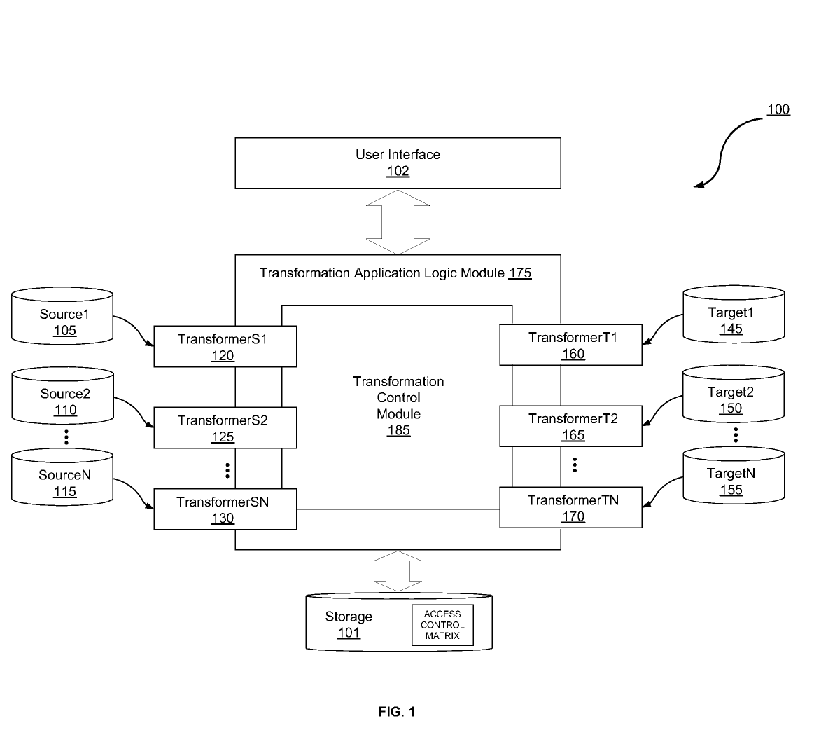

FIG. 1 is a block diagram of a system of an embodiment of the invention for transforming access control information from a source system to a target system. Referring to FIG. 1, a User Interface module 102 collects user input. The collected user input specifies a source system and a target system. Each of the source modules in system 100, Source1 105 through SourceN 115 implements a different access control model. Each source module 105 through 115 has a respective transformer module, TransformerS1 120 through TransformerSN 125 for SourceN 115. Each target module implements its own access control model and has its own transformer module, such as TransformerT1 160 through TransformerTN. For example, user input may contain Source1 105 and Target2 150. Upon receiving the user input, the Transformation Application Logic Module 175 invokes the Transformation Control Module 185. The Transformation Control Module 185 invokes TransformerS1 120 to extract an access control model form the Source1 105. TransformerS1 120 constructs an access control matrix in a native format recognized by all transformer modules. TransformerT2 165 reads the access control matrix constructed by TransformerS1 120 and converts the data in the access control matrix to the access control model for the TargetT2 150 module. The TransformerS1 120 and the TransformerT2 165 use the Transformation Control Module 185 to communicate with each other. The Transformation Control Module 185 also manages the overall conversion process. Following the conversion, the SourceS1 105 can communicate with the TargetT1 145 enforcing the correct access model and thus preserving the security semantics of both systems.

Using a system, such as the system 100 described above, has a number of benefits. First, the system 100 allows for automated generation of required access control data at the given target systems, such as the creation and maintenance of groups, roles, labels, and so on. Second, the system 100 allows for the translation between access control models in runtime, if required. Because of the described benefits, there is no need to involve human interaction to define access control data manually. Also, the system 100 is easily extensible because to accommodate the conversion of data from a new source module to a new target module it is sufficient to add a transformer module per the source and target modules and thus the system 100 would accommodate the new module with minimal effort. Third, as the access control matrix is in a native format, this means that there is no limitation to the type of source and target modules because regardless of the internal semantics of the source and target modules, each transformer understands the semantics of the access control matrix. For example, this allows for the migration of a legacy computing system to a current computing system without the need for manual definition of access control data.

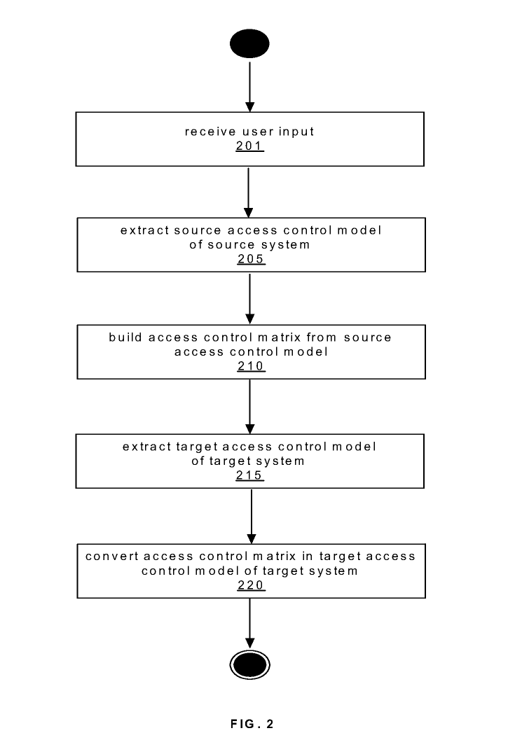

FIG. 2 is a flow diagram of an embodiment of the invention for extracting and converting access control information. Referring to FIG. 2, at process block 201, user input is received. The user input specifies a source system and a target system that need to communicate with each other but have different access control models. At process block 205, the access control model of the source system is extracted from the source system. At process block 210, an access control matrix is built from the access control model of the source system. At process block 215, the target access control model of the target system is extracted. At process block 220, the access control matrix is built at process block 210 is converted to the target access control model of process block 215. Using the method of FIG. 2, any source and target system in a heterogeneous computing environment can exchange access control data and consequently communicate with each other.

In one embodiment of the invention, the process as described in FIG. 2 is performed by a components as described in FIG. 1. The user interface 102 receives user input at process block 201 defining a source and target system, for example Source1 105 and Target2 150. At process block 210, the Transformation Application Logic Module 175 communicates the received user input to the Transformation Control Module 185 and the Transformation Control Module 185 invokes the correct transformer module for the received source system to extract the access control model of the source system (TransformerS1 120 for Source1 105). At process block 210, the invoked TransformerS1 120 builds an access control matrix from the extracted access control model. At process block 215, the Transformation Control Module 185 invokes the correct transformer module TransformerT2 165 to extract the access control model for Target2 150. At process block 220, the TransformerT2 165 converts the access control matrix to the access control model of Target2 150.

In another embodiment of the invention, the system 100 performs the process as described in FIG. 2 without the need for user input. In this embodiment, the transformation control module 185 is enhanced with internal logic that enables the transformation control module 185 to identify the source and target systems. Once the transformation control module 185 identifies the source and target systems it proceeds to identify their access control models. Thus, the transformation control module 185 has all necessary input and proceeds to invoke the relevant transformer modules so that the access control model of the source system can be converted in the access control model of the target system and vice versa. This embodiment of the invention is applied for scenarios in which source and target systems need to communicate and a transformation of their access control models must be performed during runtime. For example, a portal application may need to store the result of some processing in a database. The portal server and the database server have different access control models. In such a scenario, the transformation control module 185 will automatically establish that the source system is a portal server and the target system is a database server and invoke the relevant transformer modules so that the access control model of the portal server can be converted into the access control model of the database server and vice versa. In this way, the portal server can communicate with the database server automatically, without the need of human interaction.

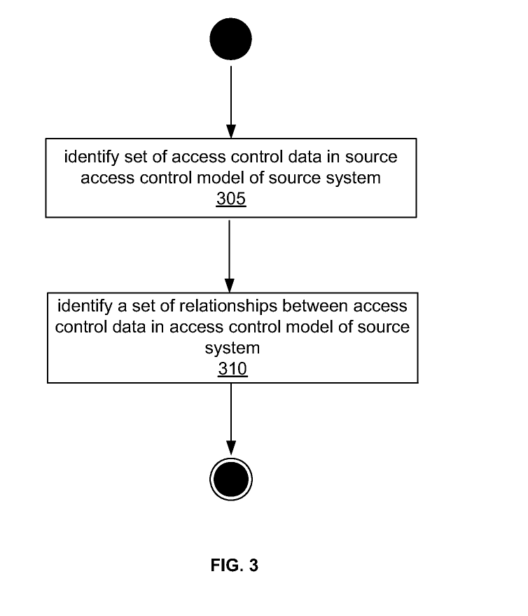

To extract the access control model of the source system, the embodiment of the invention implements a method as described in FIG. 3. Referring to FIG. 3, at process block 305, a set of access control data is identified in the access control model of the source system. At process block 310, a set of relationships between the access control data is identified. For example, if the access control model includes users and resources, the relationships identified at process block 310 define the actions that users may perform on resources, such as read, write, modify, and so on.

In one embodiment of the invention, the method as described in FIG. 3 and implemented by the process as described in FIG. 2 is performed by components as described in FIG. 1. At process block 305, TransformerS1 120 identifies the access control data in the source access control model of Source1 105. At process block 310, TransformerS1 120 identifies the relationships between the access control data in the source access control model.

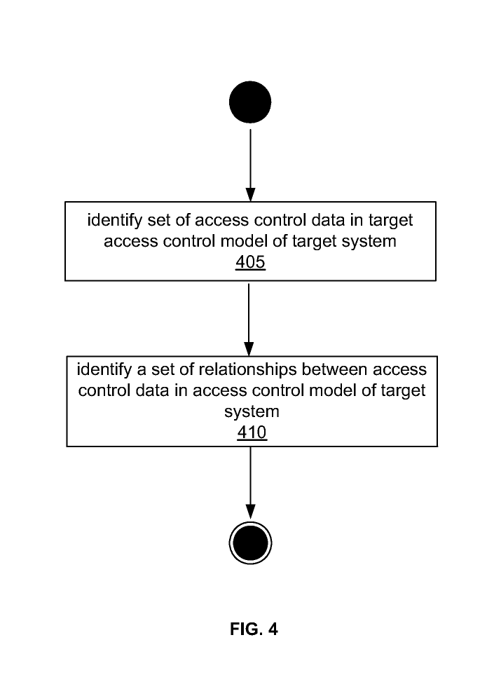

To extract the access control model of the target system, the embodiment of the invention implements a method as described in FIG. 4. Referring to FIG. 4, at process block 405, a set of access control data is identified in the access control model of the target system. At process block 410, a set of relationships between the access control data is identified. For example, if the access control model includes users, groups, and resources, the relationships identified at process block 410 define which users are included in which groups and the actions that groups may perform on resources, such as read, write, modify, and so on.

In one embodiment of the invention, the method as described in FIG. 4 and implemented by the process as described in FIG. 2 is performed by components as described in FIG. 1. At process block 405, TransformerT2 165 identifies the access control data in the target access control model of Target2 150. At process block 410, TransformerT2 165 identifies the relationships between the access control data in the target access control model.

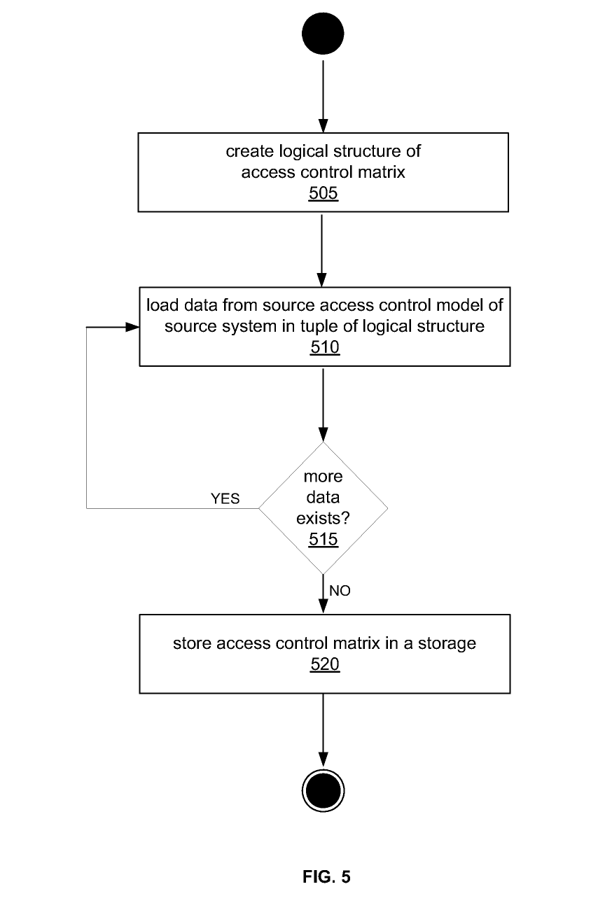

To create the access control matrix of the source system, the process described in FIG. 2 implements a method as described in FIG. 5. Once the access control data and the relationships between the data have been identified as described in FIG. 3, at process block 505, a logical structure of the access control matrix is created. The logical structure of the access control data defines the order of access control data taking into account the relationships between access control data. For example, the logical structure can define an ordered list of tuples, each tuple listing a user, a resource and an action. At process block 510, access control data is loaded from the access control model of the source system in a tuple, for example “user1, resource1, modify”. In this example, user1 is allowed to modify resource1. At process block 515, a check is performed if more access control data exists in the access control model of the source system. If there is more data in the access control model, it is loaded into the next tuple in the logical structure. If there is no more data in the access control model of the source system, the access control matrix is complete and is stored in a storage at process block 520.

In one embodiment of the invention, the method as described in FIG. 5 and implemented by the process as described in FIG. 2 is performed by components as described in FIG. 1. At process block 505, the TransformerS1 120 creates a logical structure of the access control matrix. At process block 510, TransformerS1 120 loads data from the source access control model of Source1 105 to a tuple in the created logical structure of the access control matrix. At process block 515, the TransformerS1 120 checks if there is more data in the source access control model. If there is more data in the access control model, the TransformerS1 120 proceeds to load data in a further tuple of the logical structure of the access control matrix. If no more data exists, the TransformerS1 120 completes the access control matrix and stores the access control matrix in the Storage 101 at process block 520.

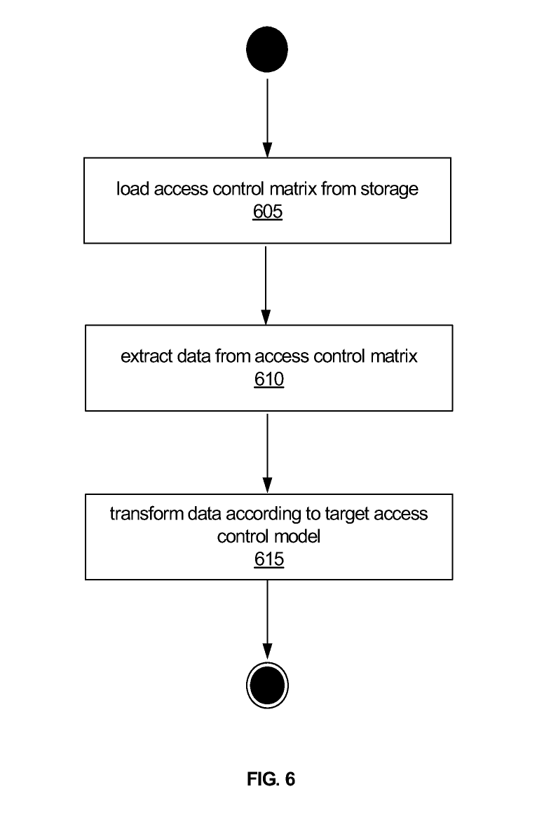

To convert the access control matrix into the access control model of the target system, the process as described in FIG. 2 implements a method as described in FIG. 6. Referring to FIG. 6, at process block 605 the created access control matrix is loaded from the storage. At process block 610, data is extracted from the access control matrix. At process block 615 the extracted data is transformed according to the extracted access control model of the target system as described in FIG. 4.

In one embodiment of the invention, the method as described in FIG. 6 and implemented by the process as described in FIG. 2 is performed by components as described in FIG. 1. At process block 605, the Transformation Control Module 185 loads the access control matrix from the storage 101. At process block 610, TransformerT2 165 extracts data from the access control matrix. At process block 615, TransformerT2 165 transforms the extracted data according to the target access control model of Target2 150.

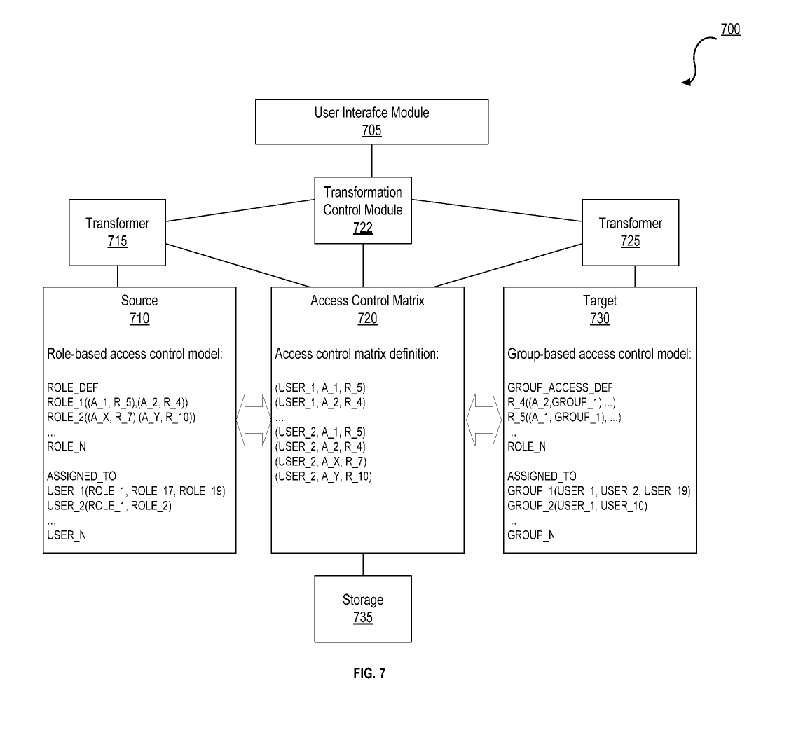

In another embodiment of the invention a system is implemented as described in FIG. 7. The system 700 includes a User Interface 705, a Source 710, and a Target 730. The Source 710 has a role-based access control model and has a Transformer 715. The Target 730 has a group-based access control model and has a Transformer 725. The role-based access control model of the Source 710 includes role definitions and assignment definitions. ROLE_DEF defines lists, that is, roles, of tuples (action, resource) that define allowed (or alternatively prohibited) actions A_1, A_2, and so on, that a given role in the Source 710 can execute on Source 710 resources R_1, R_2, and so on. For example, ROLE_1 includes (A_1, R_5). This means that ROLE_1 defines action 1 for resource 5. Further, the assignment definitions include users and roles, that is, which roles are assigned for which users. For example, USER_1 is assigned ROLE_1, ROLE_17, and ROLE_19. For example, actions can be read, write, copy, open, delete, move, and so on; and example resources can be files, database tables, datasets, pointers, programming interfaces, service interfaces, single function calls, and so on. To make an access control decision for the Source 710 in the event of an access control attempt, the system 700 uses the data in the access control model.

The Transformation Control Module 722 receives input from the User Interface 705. To enable the access between the Source 710 and the Target 730, the Transformation Control Module 722 invokes the Transformer 715. The Transformer 715 extracts the access control model of the Source 710 and builds an Access Control Matrix 720. Using the data from the extracted access control model, the Transformer 715 loads the data in tuples of the format (USER, ACTION, RESOURCE). To fill each tuple with data, the Transformer 715 loads each (ACTION, RESOURCE) tuple from ROLE_DEF of the Source 710 and identifies each user's role assignments from ASSIGNED_TO. After the all data is loaded in the Access Control Matrix 720, the Transformer 715 stores the Access Control Matrix 720 in a Storage 735.

The Target 730 has a group-based access control model and a Transformer 725. The group-based access control model for Target 730 includes group access definitions and assignment definitions. The model includes a list of tuples for every resource of (ACTION, GROUP) expressing which user groups may execute a given action on that resource. ASSIGNED_TO defines the list of users that are members of the given groups (and therefore have access to the respective resources). To convert the Access Control Matrix 720 to the group-based access control model of the Target 730, the Transformation Control Unit 722 loads the Access Control Matrix 720 from the Storage 735 and invokes the Transformer 725 to perform the conversion. The Transformer 725 searches for every resource indicated in the Access Control Matrix 720. Then the Transformer 725 collects single actions on these resources and the users who have access to these resources. If the Transformer 725 identifies users with common permissions to the same set of resources, such as USER_1 and USER_2, the Transformer 725 creates a new user group, for example, GROUP_1 with USER_1 and USER_2 as members. Following these steps the Transformer 725 converts the complete Access Control Matrix 720 to the group-based model of the Target 730. After the conversion, the system 700 can make access control decisions in the event of access control attempts thus allowing the Source 710 and Target 730 to exchange information. For example, if a distributed application requires information from both the Source 710 and the Target 730 to complete its tasks, following the performed conversion the application can complete its tasks without the need of manual definition of access control mechanisms.

In the embodiment of the invention described above, the system 700 is an exemplary system with one source and one target. Using the generic architecture described in FIG. 7, the system 700 can be implemented to include any number of sources and targets with the sources and targets having any type of access control models. Thus, the generic architecture described in FIG. 7 can be used to serve any number of scenarios involving the exchange of information between source and target computing systems in a heterogeneous environment. Further, the system as described in FIG. 7 allows for bi-directional transformations of access control data. For example, the group-based model of Target 730 can be converted to the role-based model of Source 710 following the same generic steps, as described above.

Elements of embodiments of the invention described herein may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, or other type of machine-readable media suitable for storing electronic instructions.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A computing system, comprising:
a source module including a source access control model for a first computing system, the access control model including access control data;
a target module comprising a target access control model for a second computing system, the access control model including access control data;
a source transformer module to create an access control matrix based on the access control data in the source access control model;
a target transformer module to convert the access control matrix according to the target access control model of the target module; and
a transformation control module to manage the communication between the source and target transformer modules.

2. The system of claim 1, further comprising a storage module to store the access control matrix created by the source transformer module.

3. The system of claim 1, further comprising:
a user interface module to receive user input, the user input to define the source and target modules; and
a transformation application logic module to manage the interaction between the user interface module and the transformation control module.

4. A method, comprising:
extracting a source access control model of a source system;
building an access control matrix from the extracted source access control model of the source system;
extracting a target access control model of a target system; and
converting the access control matrix to the target access control model of the target system.

5. The method of claim 4, further comprising receiving user input defining the source system and the target system.

6. The method of claim 4, wherein extracting the source access control model of the source system comprises:
identifying a set of access control data in source the access control model of the source system, the set of access control data comprising a set of users, a set of resources, and a set of actions; and
identifying a set of relationships between the access control data.

7. The method of claim 4, wherein extracting the target access control model of the target system comprises:
identifying a set of access control data in the target access control model of the target system, the set of access control data comprising a set of users, a set of resources, and a set of actions; and
identifying a set of relationships between the access control data.

8. The method of claim 4, wherein building the access control matrix of the source system comprises:
creating a logical structure for the access control matrix comprising a list of tuples, wherein each tuple comprises a user, a resource, and an action the user can perform on the resource;
loading, for each tuple in the access control matrix, data from the access control model of the source system; and
storing the access control matrix in a storage.

9. The method of claim 4, wherein converting the access control matrix comprises:
loading the access control matrix from a storage;
extracting data from the access control matrix; and
transforming the data included in the access control matrix according to the extracted target access control model of the target system.

10. A machine readable medium having instructions therein that when executed by the machine, cause the machine to:
extract a source access control model of a source system;
build an access control matrix from the extracted source access control model of the source system;
extract a target access control model of a target system; and
convert the access control matrix in the target access control model of the target system.

11. The machine-readable medium of claim 10, further comprising instructions that cause the machine to receive user input, the user input to define the source system and the target system.

12. The machine-readable medium of claim 10, wherein instructions causing the machine to extract the source access control model of the source system, cause the machine to:
identify a set of access control data in source the access control model of the source system, the set of access control data comprising a set of users, a set of resources, and a set of actions; and
identify a set of relationships between the access control data.

13. The machine-readable medium of claim 10, wherein instructions causing the machine to extract the target access control model of the target system, cause the machine to:
identify a set of access control data in the target access control model of the target system, the set of access control data comprising a set of users, a set of resources, and a set of actions; and
identify a set of relationships between the access control data.

14. The machine-readable medium of claim 10, wherein instructions causing the machine to build the access control matrix of the source system, cause the machine to:
create a logical structure for the access control matrix comprising a list of tuples, wherein each tuple comprises a user, a resource, and an action the user can perform on the resource;
load, for each tuple in the access control matrix, data from the access control model of the source system; and
store the access control matrix in a storage.

15. The machine-readable medium of claim 10, wherein instructions causing the machine to convert the access control matrix, cause the machine to:
load the access control matrix from a storage;
extract data from the access control matrix; and
transform the data included in the access control matrix according to the extracted target access control model of the target system.
